(19) United States
(12) Patent Application Publication
(10) Pub. No.: US 2012/0257949 A1
(43) Pub. Date: Oct. 11, 2012

(54) DEVICE FOR POSITIONING A MATERIAL BASKET

(76) Inventors: Michael Schmid, Bad Rippoldsau-Schapbach (DE); Ulrich Schmieder, Willstatt-Legelshurst (DE)

(21) Appl. No.: 13/382,670

(22) PCT Filed: May 18, 2010
(86) PCT No.: PCT/EP10/56759

§ 371 Date: May 2, 2012

(30) Foreign Application Priority Data
Jul. 6, 2009 (EP) 09164630.7

(51) Int. Cl. F27D 3/00; F27D 3/06; F27B 1/20

(52) U.S. Cl. 414/172; 248/681; 414/804

(57) ABSTRACT

A method and device position a deflectable material basket at a charging opening of a furnace. The method and device reliably prevent a swinging or oscillating movement of the deflectable material basket that is moved by a crane, when approaching the furnace and when discharging the material.

### CROSS REFERENCE TO RELATED APPLICATIONS

This application is based on and hereby claims priority to International Application No. PCT/EP2010/056759 filed on May 18, 2010 and European Application No. EP 09164630.7 filed on Jul. 6, 2009, the contents of which are hereby incorporated by reference.

### BACKGROUND

The invention relates to a method and device for positioning a deflectable material basket at a charging opening of a furnace.

Different procedural methods are known for filling a furnace with charging material to be melted. In this situation, material baskets are frequently employed as transportation facilities for the charging material and are conveyed up to a charging opening of the furnace by a crane. The charging material, which for example in the case of a metal smelting furnace mainly comprises scrap metal but also additives and the like, is emptied into the charging opening and smelted in the furnace.

When a material basket is transported to the furnace from a loading station in which an empty material basket is filled with charging material, the material basket is normally suspended freely on a crane cable. As a result of the sideways movement and the braking in the area of the charging opening a deflection of the material basket occurs which results in the material basket swinging or oscillating. This makes it more difficult to correctly and efficiently position the material basket over the charging opening.

The German patent specification No. 560 041 already discloses a charging device for furnaces which reduces a deflection and consequently a swinging or oscillating movement of a charging container or material basket moved by a crane. To this end, the lifted charging container is supported against the vehicle of the crane and as if it were rigidly connected to the latter such that swinging or oscillating cannot occur during transportation. The charging container fixed in this manner is transported in this position until it is emptied. There is no longer any change in the spacing between the crane vehicle and the charging container, which means that the running rails of the crane and/or the charging opening need to be disposed correspondingly in order to transport the charging container directly towards the charging opening and to enable the charging material to be poured in.

In practice, such a procedure is for the most part not possible. Because of local conditions it is therefore necessary as a general rule to lift the material basket using the crane, transport it a certain distance and then lower it again. At least when being lowered the material basket is suspended freely on the crane cable or on chains and a deflection occurs which causes a swinging or oscillating movement. Any uneven loading moreover causes the material basket to hang askew. An efficient and at the same time exact positioning of the material basket accordingly still proves to be difficult. Finally, emptying the material basket also causes a deflection of the material basket, whereby enormous damage can be caused in the area of the charging opening and its peripheral equipment.

### SUMMARY

One possible object is therefore to enable improved positioning of a deflectable material basket at a charging opening of a furnace.

The inventors propose a device for positioning a deflectable material basket at a charging opening of a furnace. The device has a guide rail system disposed at the charging opening which
comprises at least two horizontally oriented guide rails which act as a lateral guide for the material basket,
comprises at least one stop, up to which the material basket can be guided along the at least two guide rails, and
comprises at least one locking facility, by which a deflection of the material basket at the charging opening can be prevented.

In this situation the expression “deflectable material basket” describes that the material basket has a suspension which allows a horizontal deflection in at least two directions, preferably in all directions. This facility includes for example a cable suspension, chain suspension, pendulum suspension and the like.

The proposed guide rail system of the device allows a deflectable material basket to be transported in a particularly simple and uncomplicated fashion towards a charging opening disposed as desired opposite the crane. The swinging or oscillation of the material basket occurring during the approach of the material basket is intercepted and stopped by the guide rail system. This results in a reduction in the idle time of the furnace, whereby up to one minute of time can be saved per charging operation. This corresponds to an approximate increase in production of 3 to 5%.

In addition, the at least one locking facility of the guide rail system reliably prevents any deflection of the material basket during emptying of the charging material, with the result that no damage is caused by the material basket to the charging opening or to components disposed in the area of the charging opening. In this situation, the stop can be a part of such a locking facility or can also be disposed separately from it.

A positioning of the material basket applies here not only in the case where the material basket is fixed immovably horizontally in all directions in the device but also when the material basket remains movable horizontally in the locked position with a small amount of play. A small amount of play is understood in this situation such that in the locked state the material basket can move horizontally in each direction in the device by a maximum of up to 50 mm, in particular by a maximum of up to 30 mm.

It has proved worthwhile if the at least two guide rails are disposed spaced apart from one another and parallel to one another at least in sections in such a manner that the material basket can be guided along and between the guide rails up to the at least one stop. The at least two guide rails confine the material basket in this embodiment at its two sides such that a lateral deflection is inhibited.

The at least two guide rails can alternatively or in combination therewith be disposed spaced apart from one another and at least in sections in such a manner that the material basket can be guided along and between the guide rails up to the at least one stop, whereby the spacing between the guide rails reduces in the direction of the at least one stop. This is then in particular advantageous if a swinging or oscillation movement of the material basket between the guide rails is to be slowly decelerated.

It is particularly preferred in this connection if in a first section of the guide rail system which is the first to come into contact with the material basket the spacing between the guide rails reduces in the direction of the at least one stop and in a following—viewed in the direction of movement of the material basket—second section of the guide rail system the guide rails are disposed parallel or essentially parallel to one another.

The at least one stop of the guide rail system prevents a further forward movement of the material basket, such that the latter preferably has its freedom of movement restricted at two sides by guide rails and at a third side by the stop.

The at least one locking facility is advantageously designed in such a manner that components of the at least one locking facility and of the material basket are interlocked and/or are intermeshed with one another. The at least one locking facility fixes the material basket on the guide rail system such that its freedom of movement is also restricted in the direction of a fourth side. A horizontal deflection of the material basket at the charging opening is no longer possible as a result of engagement or intermeshing of the material basket in the at least one locking facility.

By preference, the at least one locking facility comprises at least two perpendicularly disposed sleeve-like zones, into which can be introduced pins disposed perpendicularly on the material basket. For example, pins can also be situated on the guide rail system and sleeve-like zones on the material basket, etc. Alternatively, other interlocking or intermeshing systems which are disposed on the material basket and on the device and operate in accordance with a lock-and-key principle can however also be employed here without any difficulty.

It has proved worthwhile if the device furthermore comprises a hopper for receiving the material basket, which is disposed between the guide rail system and the charging opening. The hopper is intended in particular to completely accept the charging material, to decelerate the fall of the charging material and to channel the fall in the desired direction.

In particular, the hopper comprises a hopper flap on one side in this situation. This is preferably situated on the side of the hopper from which the material basket approaches. The hopper flap can preferably be actuated mechanically or hydraulically. When the material basket approaches the guide rail system the hopper flap is opened and at the same time lowered, the material basket enters the hopper and the hopper flap is closed again. This enables the floor of the material basket to be disposed inside the hopper. This serves to prevent parts of the charging material falling past instead of into the furnace when the material basket is emptied.

If the hopper is designed without a hopper flap, the hopper is preferably disposed or suspended between the charging opening and the guide rail system such that the material basket can be transported over the hopper without any difficulty at least during the approach operation. A height-adjustable hopper has also proved its worth in this case.

A furnace which comprises a shaft having a charging opening, and a shaft gate for opening and closing the charging opening, and which is equipped with the proposed device, has proved to be particularly advantageous. In a preferred embodiment the furnace is a metal smelting furnace, in particular an electric arc furnace. Scrap metal is mainly used as the charging material for a metal smelting furnace.

The device is disposed preferably above the charging opening on the furnace. In this situation, the charging opening can be situated perpendicularly beneath the device, such that the charging material can fall directly into it. Alternatively, the device can however also be situated laterally displaced above the charging opening, whereby the charging material is guided by way of a chute into the charging opening.

Furthermore, a method for positioning a deflectable material basket at a charging opening of a furnace which is equipped with the proposed device has proved its worth, whereby the method comprises:

a) transporting the material basket by a crane to the at least two guide rails of the device;

b) transporting the material basket by a crane along the at least two guide rails in the direction of the at least one stop until the at least one stop is reached; and

c) lowering the material basket by the crane, whereby the material basket is locked opposite the charging opening by the at least one locking facility.

A particularly rapid and precise positioning of the material basket opposite the charging opening is thereby enabled.

By preference, in step a) the material basket is transported between the at least two guide rails in the direction of the at least one stop. Alternatively, the guide rails could be disposed in such a manner that they merely support and guide the material basket on one side. In this case, the material basket would not be transported between, but merely along, the guide rails and lean against the latter.

After step c) the material basket is preferably still carried completely by the crane. This serves to reliably prevent the material basket becoming detached from the crane suspension and consequently no longer being capable of being transported away efficiently after being emptied.

Furthermore, a method for charging a furnace with charging material has proved its worth, which furnace comprises a shaft having a charging opening and a shaft gate for opening and closing the charging opening, and which is equipped with the proposed device, comprising:

a) transporting a deflectable material basket containing charging material by a crane to the at least two guide rails of the device;

b) transporting the material basket by the crane along the at least two guide rails in the direction of the at least one stop until the at least one stop is reached;

c) lowering the material basket by the crane, whereby the material basket is locked opposite the charging opening by the at least one locking facility;

d) opening the shaft gate; and

e) opening at least one base flap on the material basket, thereby emptying the charging material into the shaft.

As a result of the procedure to position the material basket opposite the charging opening before the shaft gate is opened, time is saved for the charging operation and the production output of the furnace is increased.

The shaft gate is subsequently closed again and the emptied material basket is removed by the crane.

As needed, the charging operation is repeated until the intake capacity of the furnace for the molten mass produced from the charging material is reached.

In the event that the furnace in question is a metal smelting furnace in the form of an electric arc furnace, the energy input to the electric arc furnace is interrupted before the shaft gate is opened.

The at least one base flap on the material basket is preferably actuated mechanically, pneumatically or hydraulically. In this situation, a base flap can be designed not only in the form of a continuous plate, but also as having openings and/or subdivisions. By preference, the material basket comprises an arched floor which is formed by two base flaps which can be swiveled to the side.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a three-dimensional view of a device;

FIG. 2 shows an exploded view of the device according to FIG. 1 above a shaft gate; and

FIGS. 3 to 5 show the course of events of a method for positioning a material basket or charging a furnace.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

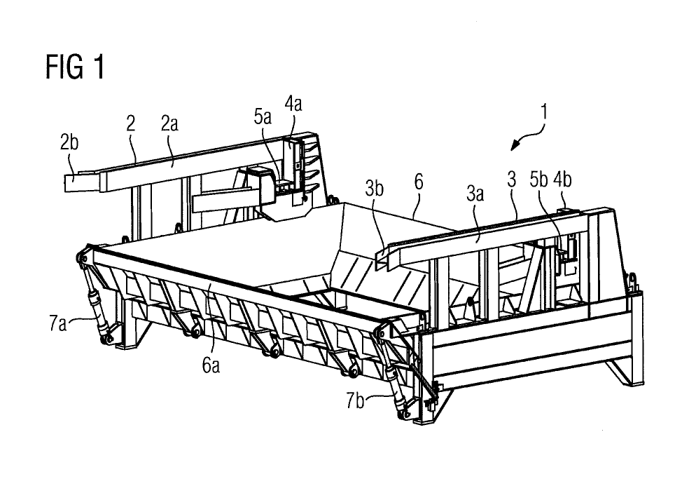

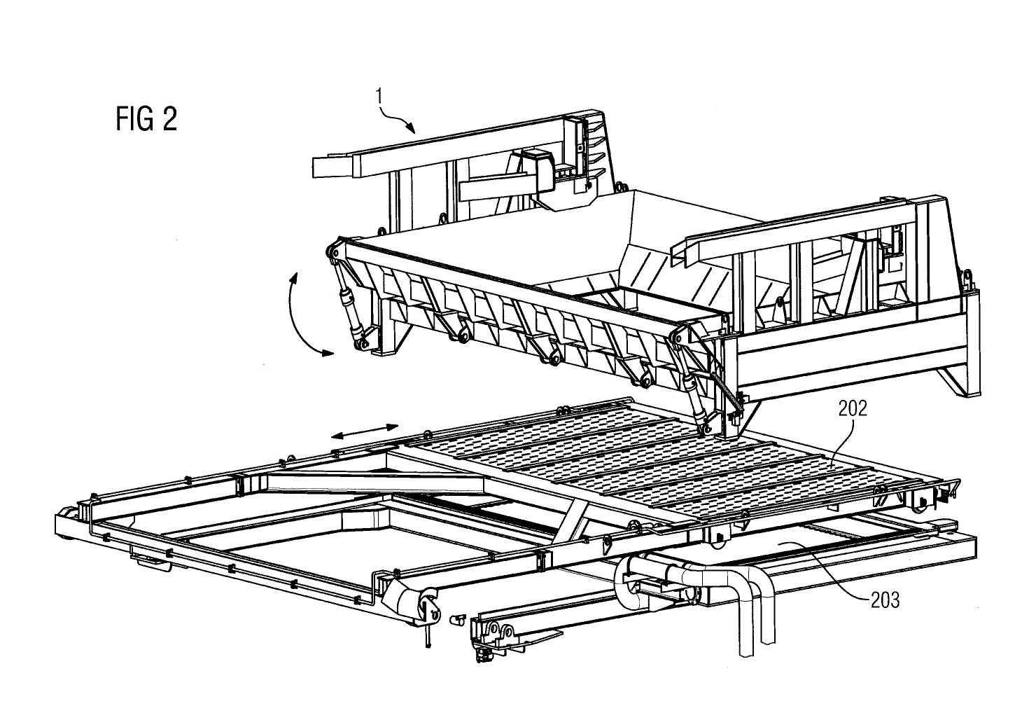

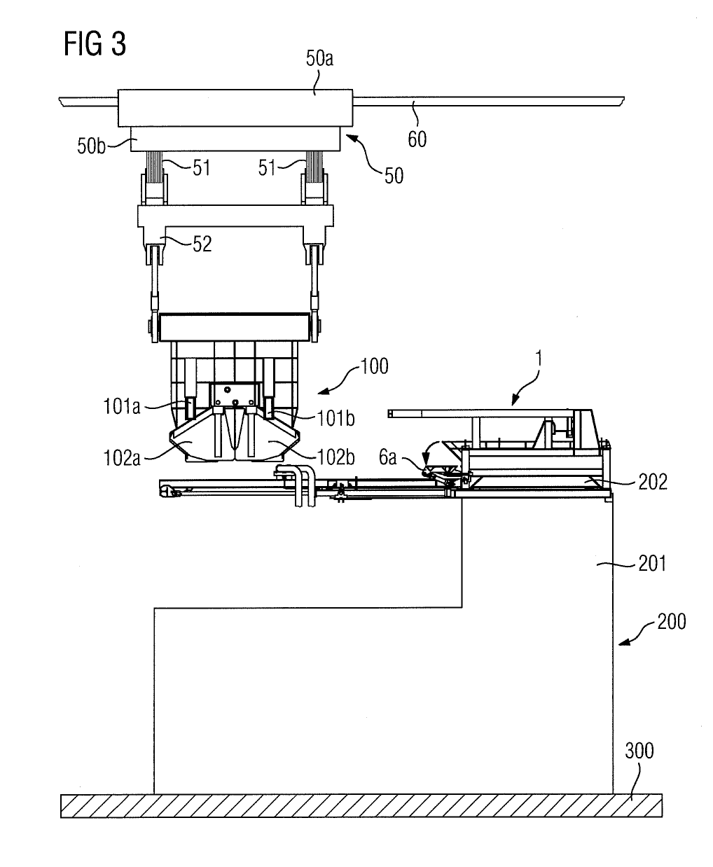

FIG. 1 shows a device 1 which is used for positioning a deflectable material basket 100 over a charging opening 203 of a furnace 200 (cf. FIGS. 2 and 3). The device 1 comprises a guide rail system which here comprises two horizontally oriented guide rails 2, 3 that act as a lateral guide for the material basket 100, two stops 4a, 4b up to which the material basket 100 can be guided along the two guide rails 2, 3, and two locking facilities 5a, 5b, by which the material basket 100 can be locked opposite the charging opening 203. The device 1 here furthermore comprises a hopper 6 which however is only present as an option. The hopper 6 comprises on one side a hopper flap 6a which can be moved by hydraulic lifting cylinders 7a, 7b and in the opened state enables the material basket 100 to be transported into or out of the device 1.

In the region of the hopper flap 6a the guide rails 2, 3 comprise sections 2b, 3b, the spacing of which decreases in the direction of the stops 4a, 4b. The mounting of the material basket 100 between the guide rails 2, 3 is thereby facilitated. The guide rails 2, 3 subsequently comprise further sections 2a, 3a which run parallel or essentially parallel to one another.

FIG. 2 shows an exploded view of the device 1 according to FIG. 1 above a shaft gate 202. The shaft gate 202 covers a charging opening 203 belonging to a furnace 200 which is not shown here for the sake of clarity (cf. FIG. 3). The shaft gate 202 can be actuated hydraulically, pneumatically or also mechanically for opening and closing the charging opening 203.

FIGS. 3 to 5 show a side view of the course of events of a method for positioning a deflectable material basket 100 over a charging opening 203 of a furnace 200 or for charging the furnace 200 which is equipped with a device 1 according to FIG. 1. The device 1 is situated in this case above the charging opening 203 such that the material basket 100 transported into the device 1 is situated perpendicularly above the charging opening 203.

The material basket 100 is transported in the direction of the furnace 200 (see arrow) by a crane 50 in the form of an overhead crane which comprises a gantry crane 50a on a track system 60 having a traveling trolley 50b. In this situation the material basket 100 is suspended on a hook cross-beam 52 which is secured on crane cables 51 and can be deflected horizontally in all directions, which means that a swinging or oscillating movement of the material basket 100 can occur when the material basket 100 is being transported and emptied.

The material basket 100 comprises two base flaps 102a, 102b which can be opened and closed hydraulically. Furthermore, two pins 101a, 101b in each case are disposed on each side of the material basket 100. In each case the pins 101b, which reach the device 1 first, are locked in the locking facilities 5a, 5b of the device 1. The other two pins 101a are used for example if the material basket 100 is transported into the device 1 turned through 180 degrees.

The furnace 200 which is represented only schematically is situated on a furnace platform 300 and comprises a shaft 201 with the charging opening 203 (see FIG. 2) which is closed by the shaft gate 202.

The material basket 100 is transported according to FIG. 3 by the crane 50 with the hopper flap 6a opened to the guide rails 2, 3 of the device 1 and moved along and between the guide rails 2, 3 in the direction of the stops 4a, 4b until the stops 4a, 4b of the device 1 are reached and the movement of the material basket 100 is stopped thereby.

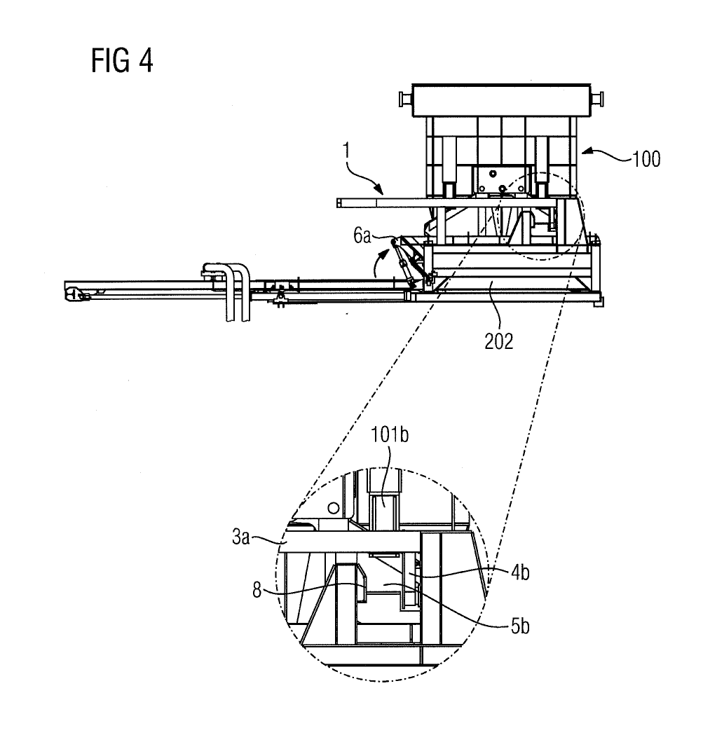

FIG. 4 shows the material basket 100 and the shaft gate 202 according to FIG. 3 after the material basket 100 has been transported into the device 1. To provide a clearer overview, the other components illustrated in FIG. 3 have been omitted from the illustration here. These are however still intended to be present. The material basket 100 has been transported into the device 1 up to the stops 4a, 4b. The hopper flap 6a has been closed again behind the material basket 100. The area in which the locking facility 5b is situated can be recognized in the detail enlargement. The pin 101b of the material basket 100 is situated above a sleeve-like zone of the locking facility 5b which is delimited to the one side by the stop 4b and to the other side by a stopper element 8. In the area of the locking facility 5a, not visible here, is situated a further pin of the material basket in the same position.

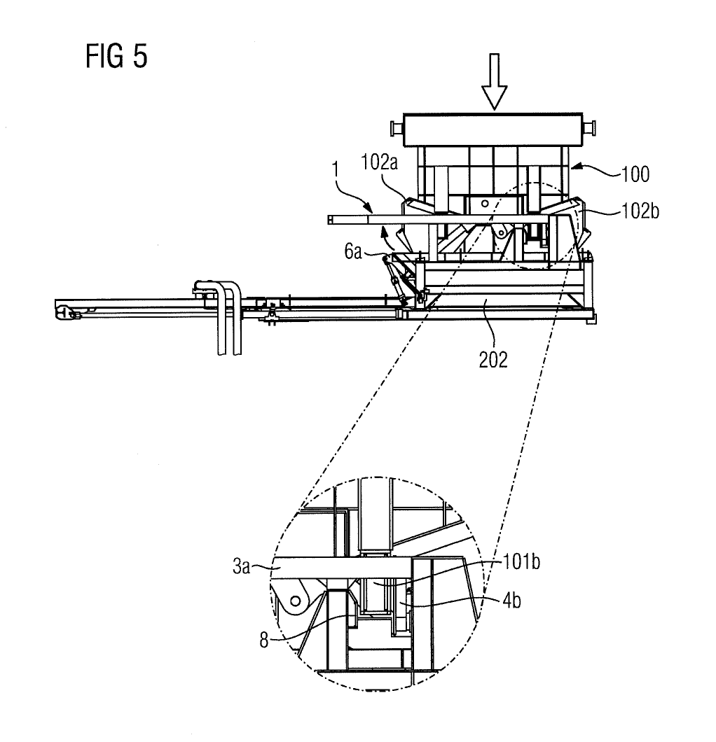

According to FIG. 5, the material basket 100 is now lowered by the crane 50 (see arrow above material basket 100). In this situation the material basket 100 is locked by the locking facilities 5a, 5b above the charging opening 203 of the furnace 200. The pins 101b on the material basket 100 engage in the sleeve-like zones of the locking facilities 5a, 5b such that a movement of the material basket 100 against the direction of entry into the device 1 is prevented by the stopper element 8 of each locking facility 5a, 5b.

The material basket 100 is now fixed against any deflection in the horizontal direction by the guide rails 2, 3 and the locking facilities 5a, 5b, in detail the stops 4a, 4b and the respective stopper element 8. In this situation, the material basket 100 is still suspended completely from the crane 50, which means that the crane cables 51 remain tensioned and cannot become detached from the material basket 100.

Only then is the shaft gate 202 opened, which releases the charging opening 203 of the furnace 200. Opening the base flaps 102a, 102b (see arrows) allows the charging material with which the material basket 100 was loaded to fall through the hopper 6 of the device 1 into the charging opening 203 and through the shaft 201 into the furnace 200, where it is melted after the shaft gate 202 has been closed.

During emptying, the material basket 100 is fixed and cannot cause any damage as a result of swinging or oscillation in the area of the charging opening 203 or other adjacent components of the furnace.

The emptied material basket 100 can either be removed upwards from the device 1 by the crane with the base flaps 102a, 102b open or closed again, or alternatively after being lifted into the position according to FIG. 4 by the crane 50 and after opening of the hopper flap 6a can be transported out of the device 1 again until the position according to FIG. 3 has again been reached.

The emptied material basket 100 can now be loaded again with charging material and the positioning operation repeated.

It is self-evident in this situation that the material basket illustrated in FIGS. 3 to 5 merely represents one possible example of such a basket. The form, mode of operation and suspension of the material basket can accordingly be designed differently without departing from the fundamental ideas described herein. Furthermore, a person skilled in the art is readily able to adjust the arrangement and embodiment of the device 1 to the particular furnace to be charged.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-16. (canceled)

17. A device for positioning a deflectable material basket at a charging opening of a furnace, comprising:
a guide rail system disposed at the charging opening, the guide rail system having at least two horizontally oriented guide rails which act as a lateral guide for the material basket from a first end to a second end of the guide rail system;
a stop provided at the second end of the guide rail system, up to which the material basket can be guided along the at least two guide rails; and
a locking facility provided at the second end of the guide rail system, to prevent deflection of the material basket when the material basket is positioned opposite the charging opening.

18. The device as claimed in claim 17, wherein
the two guide rails are spaced apart from one another and parallel to one another at least in one section such that the material basket is guided along and between the guide rails up to the stop.

19. The device as claimed in claim 18, wherein
the guide rails have a first section toward the first end of the guide rail system and a second section toward the second end of the guide rail system,
in the second, the guide rails are substantially parallel,
in the first section, the guide rails are spaced apart from one another with a spacing between the guide rails that reduces toward the stop.

20. The device as claimed in claim 17, wherein the locking facility has a locking component that interlocks and/or intermeshes with a locking component on the material basket.

21. The device as claimed in claim 20, wherein
the locking facility comprises at least two sleeve-like zones extending perpendicular to the horizontally oriented guide rails, and
the sleeve-like zones receive vertical pin projections provided on the material basket.

22. The device as claimed in claim 17, further comprising a hopper provided between the guide rails and in the vicinity of the charging opening, to receive the material basket.

23. The device as claimed in claim 22, wherein the hopper comprises a hopper flap on one side.

24. The device as claimed in claim 23, wherein the hopper flap is mechanically or hydraulically actuated and movable between a closed position and an open, basket-receiving position.

25. A furnace, comprising:
a shaft having a charging opening to receive material;
a shaft gate to open and close the charging opening;
a guide rail system disposed at the charging opening, the guide rail system having at least two horizontally oriented guide rails which act as a lateral guide for the material basket from a first end to a second end of the guide rail system;
a stop provided at the second end of the guide rail system, up to which the material basket can be guided along the at least two guide rails; and
a locking facility provided at the second end of the guide rail system, to prevent deflection of the material basket when the material basket is positioned opposite the charging opening.

26. The furnace as claimed in claim 25, wherein the furnace is a metal smelting furnace.

27. The furnace as claimed in claim 25, wherein
the shaft extends vertically and terminates in a horizontally oriented charging opening, and
the guide rail system, stop and locking facility are fixed vertically above the charging opening.

28. A method for positioning a deflectable material basket at a charging opening of a furnace, comprising:
transporting the material basket using a crane, to a guide rail system disposed at the charging opening, the guide rail system having at least two horizontally oriented guide rails that extend from a first end to a second end of the guide rail system;
transporting the material basket using the crane, from the first end to the second end of the guide rail system, the material basked being transported along the guide rails so that the guide rails act as a lateral guide for the material basket from the first end to the second end of the guide rail system;
using a stop to terminate lateral movement of the material basket at the second end of the guide rail system;
lowering the material basket using the crane; and
locking the material basket in place opposite the charging opening using a locking facility.

29. The method as claimed in claim 28, wherein the material basket is transported between the guide rails to the second end of the guide rail system.

30. The method as claimed in claim 28, wherein the material basket is completely supported by the crane after the material basket is lowered and locked in place.

31. The method as claimed in claim 28, further comprising:
opening a shaft gate provided on a furnace shaft at the charging opening; and
opening a base flap on the material basket, thereby emptying the material into the furnace shaft.

32. The method as claimed in claim 31, wherein the base flap on the material basket is actuated mechanically or hydraulically.
